(19) United States
(12) Patent Application Publication
(10) Pub. No.: US 2024/0134225 A1
(43) Pub. Date: Apr. 25, 2024

(54) OPTICAL FILM, DISPLAY MODULE, AND DISPLAY SCREEN

(71) Applicants: Wen-Feng Cheng, Taoyuan City (TW); Sunrise Optronics Co., Ltd, Taoyuan City (TW)

(72) Inventor: Wen-Feng Cheng, Taoyuan City (TW)

(73) Assignees: Wen-Feng Cheng, Taoyuan City (TW); Sunrise Optronics Co., Ltd, Taoyuan City (TW)

(21) Appl. No.: 18/382,530

(22) Filed: Oct. 22, 2023

Related U.S. Application Data
(60) Provisional application No. 63/418,608, filed on Oct. 23, 2022.

(51) Int. Cl. G02F 1/1335; G02F 1/13357; H04N 9/31

(52) U.S. Cl. CPC G02F 1/13355; G02F 1/133606; H04N 9/3105

(57) ABSTRACT

An optical film, display module, and display screen, wherein the optical film comprises a main body, multiple microstructures, and an opaque layer. The microstructures are positioned on one side of the main body, and these microstructures are protruding arcuate structures. The opaque layer is affixed to the main body and is set opposite the microstructures on the other side of the main body, the opaque layer includes multiple apertures. Wherein, the center point of the apertures overlaps with the center point of the microstructures on a projection plane. Wherein, the equivalent diameter of the apertures divided by the equivalent diameter of the microstructures is less than or equal to 0.3, the equivalent diameter of the microstructures divided by the thickness of the main body is less than or equal to 1.3, and greater than or equal to 0.7. Wherein, the opaque layer is oriented towards the light source. The beneficial effect is that it can produce better collimated light, further improving the performance of the display module.

### BACKGROUND OF THE INVENTION

### 1. Field of the Invention

This relates to an optical film, particularly an optical film for use in display modules or micro-projection systems.

### 2. Description of the Prior Art

Optical modules are widely used in many products, such as displays, fiber optic communications, medical instruments, etc. Among them, display modules are extensively used in liquid crystal displays (LCDs), their main function being to provide a uniform light source to display clear images.

Traditional display modules mostly use tubes or LEDs as light sources, and are combined with other optical components (such as diffuser plates, light guide plates, reflector plates, etc.) to adjust the light source to achieve a uniform brightness effect. This design of display module usually includes multiple complex optical components, which increases the manufacturing steps, raises the cost, and also increases the difficulty of assembly.

To solve these problems, some advanced display module designs have adopted microstructure technology. This technology can design multiple optical functions on a single optical component, such as reflection, refraction, diffusion, etc., thereby achieving the purpose of controlling the light path and thereby improving the uniformity of brightness.

However, although this type of microstructure design is theoretically feasible, it faces many challenges in actual manufacturing. For example, the production of microstructures requires precise lithography technology, and this technology requires higher costs and technical thresholds. On the other hand, existing microstructure designs often fail to achieve the optimum optical effect, because their ability to control the light path is still limited, especially when dealing with high brightness or large viewing angle applications, the effect is often not as expected.

In summary, although the design of existing display modules has made some progress, there are still many problems to be solved. For example, the cost and complexity of existing designs are still high, and the optical performance still has room for improvement. Therefore, there is still a great demand for new designs and manufacturing technologies for display modules.

### SUMMARY OF THE INVENTION

In view of the above problems, this patent proposes an optical film that uses a combination of microstructure lenses and apertures in its design, which can produce better collimated light and further improve the performance of the display module. The specific technical means are as follows:

An optical film, suitable as a component of an optical device that includes a light source, characterized in that the optical film includes a main body, multiple microstructures, and an opaque layer. The microstructures are positioned on one side of the main body and are protruding arcuate structures. An opaque layer is affixed to the main body and is set opposite the microstructures on the other side of the main body, the opaque layer includes multiple apertures. Wherein, the center point of the apertures overlaps with the center point of the microstructures on a projection plane. Wherein, the equivalent diameter of the apertures divided by the equivalent diameter of the microstructures is less than or equal to 0.3, the equivalent diameter of the microstructures divided by the thickness of the main body is less than or equal to 1.3, and greater than or equal to 0.7. Wherein, the opaque layer is oriented towards the light source.

In the above optical film, it is characterized in that the microstructures and the apertures are uniformly arranged on the main body.

In the above optical film, it is characterized in that the microstructures and the apertures are arranged in an array pattern.

In the above optical film, it is characterized in that the microstructures and the apertures are arranged in a honeycomb pattern.

In the above optical film, it is characterized in that the microstructures and the apertures are randomly arranged on the main body.

In the above optical film, it is characterized in that the microstructures intersect with each other on the main body.

In the above optical film, it is characterized in that the opaque layer is composed of light-absorbing material.

In the above optical film, it is characterized in that the main body is made of polycarbonate (PC), polymethyl methacrylate (PMMA), polyethylene terephthalate (PET), or glass, and the opaque layer is made of nickel, silver, gold, aluminum, titanium dioxide, or silicon dioxide.

In the above optical film, it is characterized in that the opaque layer is a reflective material.

This patent also provides a display module, characterized in that it includes at least one of the above optical films and multiple light sources. The light sources are placed below the optical film. It is characterized in that the optical film is oriented with the side having the opaque layer facing the light sources.

In the above display module, it is characterized in that it further includes at least one diffusion layer, positioned between the optical film and the light sources.

In the above display module, it is characterized in that the diffusion layer is affixed to the underside of the optical film.

In the above display module, it is characterized in that it further includes a liquid crystal panel, positioned above the optical film.

In the above display module, it is characterized in that it further includes a polarizing beam splitter and a spatial light modulator, with the polarizing beam splitter placed above the optical film. The light emitted by the light sources is reflected by the polarizing beam splitter to the spatial light modulator.

This patent also provides a display screen, characterized in that it includes a display module and at least one of the above optical films. The optical film is affixed to the display module, and the optical film is oriented such that the side with the opaque layer faces the display module. The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 illustrates the optical film of this patent.

FIG. 2 illustrates the schematic diagram of the optical film and the light source.

FIGS. 3 and 4 illustrate the array arrangement of the microstructures and apertures.

FIGS. 5 and 6 illustrate the honeycomb arrangement of the microstructures and apertures.

FIGS. 7 and 8 illustrate the random arrangement of the microstructures and apertures.

FIGS. 9 to 11 illustrate the array and intersecting arrangement of the microstructures.

FIGS. 12 to 14 illustrate the honeycomb arrangement and intersecting arrangement of the microstructures.

FIGS. 15 and 16 to 28 illustrate the manufacturing method of the optical film of this patent.

FIG. 29 illustrates the optical simulation result table.

FIGS. 30 to 33 are light distribution simulation diagrams.

FIGS. 34 and 35 illustrate the light distribution graph.

FIGS. 36 to 39 illustrate the light distribution simulation diagrams of another embodiment.

FIGS. 40 and 41 illustrate the light distribution graph.

FIG. 42 illustrates the first embodiment of the application.

FIG. 43 illustrates the second embodiment of the application.

FIG. 44 illustrates the third embodiment of the application.

FIG. 45 illustrates the fourth embodiment of the application.

FIG. 46 illustrates the fifth embodiment of the application.

FIG. 47 illustrates the sixth embodiment of the application.

FIG. 48 illustrates the seventh embodiment of the application.

### DESCRIPTION OF THE PREFERRED EMBODIMENTS

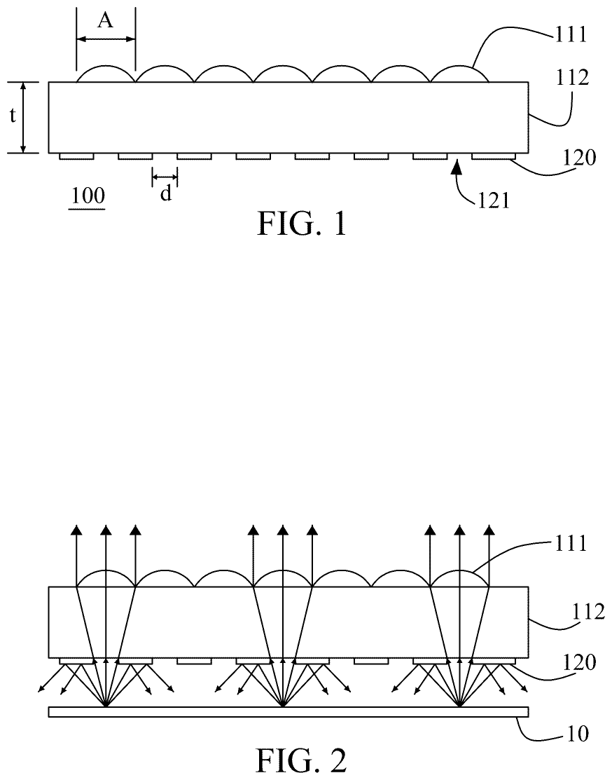

Refer to FIG. 1, which illustrates the optical film 100 of this patent. This optical film 100 is suitable as a component of an optical device that includes at least one light source. The optical device, for example, can be a display device or a backlight module (Backlight Module), and the light source refers to the LED in the display device or backlight module.

This optical film 100 of the patent includes multiple microstructures 111, a main body 112, and an opaque layer 120. The main body 112 can be made of a transparent material, such as polycarbonate (PC), polymethyl methacrylate (PMMA), polyethylene terephthalate (PET), or glass. Multiple microstructures 111 are positioned on one side of the main body 112, and these microstructures 111 are protruding arcuate structures.

Among them, the thickness of the main body 112 and the equivalent diameter of the microstructures 111 can be determined by optical properties and actual requirements, but the thickness of the main body 112 and the equivalent diameter of the microstructures 111 have a specific proportional relationship. In this embodiment, the equivalent diameter A of the microstructures 111 divided by the thickness t of the main body 112 is less than or equal to 1.3 and greater than or equal to 0.7, that is.

The opaque layer 120 is set on the other side of the main body 112 opposite to the microstructures 111, and is set by the side of the opaque layer 120 facing the light source, that is, the opaque layer 120 is set on the light entrance surface of the optical film 100, and the microstructures 111 are set on the light exit surface of the optical film 100. The opaque layer 120 can be made of opaque materials such as nickel, silver, gold, aluminum, titanium dioxide, or silicon dioxide. In one embodiment, the opaque layer 120 can also choose reflective material to reflect light from the light source. In another embodiment, the opaque layer 120 is composed of light-absorbing material, for example, it is formed by black ink.

Furthermore, the opaque layer 120 also includes multiple apertures 121. The design of these apertures 121 allows light to pass through the optical film 100 from specific angles. The positions of the microstructures 111 and the apertures 121 correspond to each other, specifically, the center point of the apertures 121 overlaps with the center point of the microstructures 111 on a projection plane. And the equivalent diameter of the microstructures 111 and the equivalent diameter of the apertures 121 are related. In this embodiment, the equivalent diameter d of the apertures 121 divided by the equivalent diameter A of the microstructures 111 is less than or equal to 0.3, that is.

Refer to FIG. 2, which illustrates the optical film 100 and the light source. When the optical film 100 is set on the light source module 10, and the side of the opaque layer 120 is aligned with the light source, the light emitted by the light source will first encounter the opaque layer 120. Some large-angle light will be blocked by the opaque layer 120, and another part of the small-angle light will pass through the apertures 121 on the opaque layer 120 and enter the main body 112. Since the positions of the apertures 121 and the microstructures 111 correspond to each other, the light passing through the apertures 121 will further pass through the microstructures 111. In addition, if the opaque layer 120 chooses reflective material, it can reflect the light of the light source module 10, and match the reflector of the light source module 10 itself, so that the light originally blocked by the opaque layer 120 can pass through the apertures 121 after reflection, thereby reducing the overall brightness loss.

At this stage, because the microstructures 111 adopt an arcuate shape, the microstructures 111 can produce a lens effect, making the light passing through the microstructures 111 form collimated light (Collimated beam) when it is emitted. This provides effective control for the conduction of light, allowing the light to be emitted in a specific way and to play a role in subsequent applications, such as being used as a privacy film for display modules or display panels.

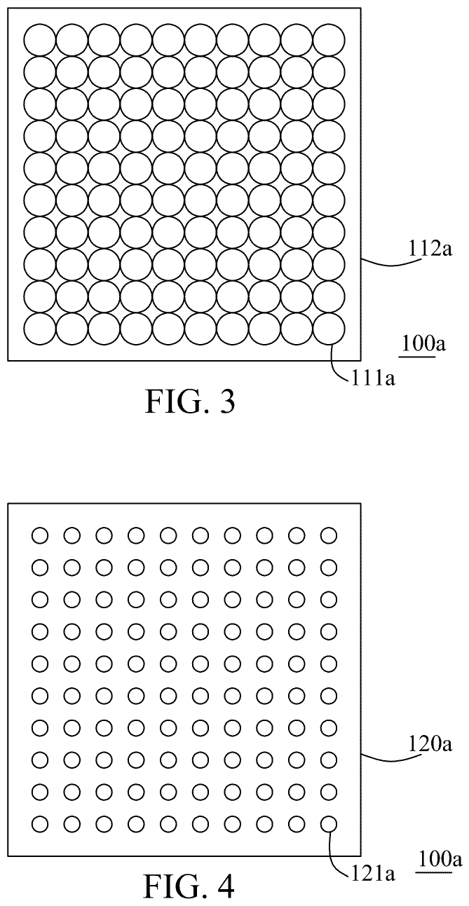

In addition, the microstructures 111 and the apertures 121 can be arranged in different ways. Refer to FIGS. 3 and 4, which illustrate the array arrangement of the microstructures 111a and the apertures 121a. In this embodiment, the microstructures 111a and the apertures 121a are arranged in an array form on the optical film 100a in an average, and horizontally and vertically aligned manner.

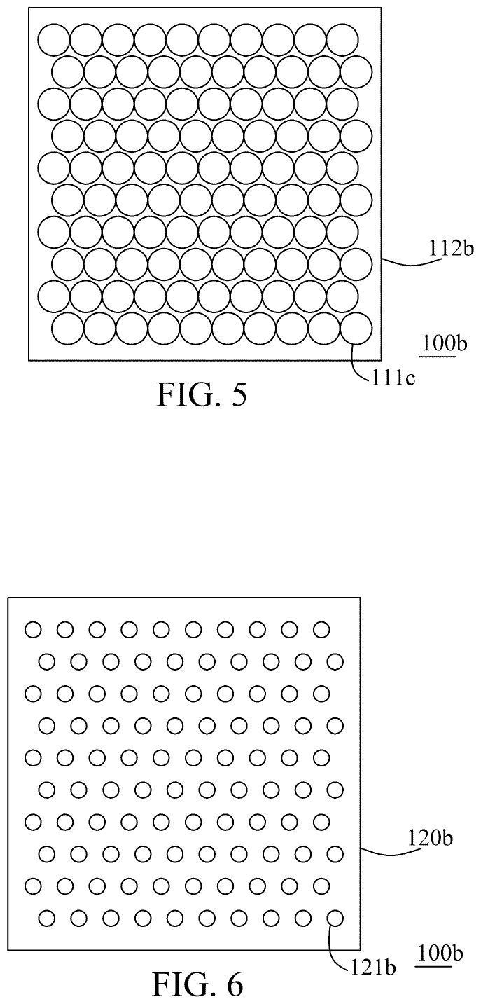

Refer to FIGS. 5 and 6, which illustrate the honeycomb arrangement of the microstructures 111b and the apertures 121b. In this embodiment, the microstructures 111b and the apertures 121b are staggered on the vertical line, thereby producing a honeycomb arrangement.

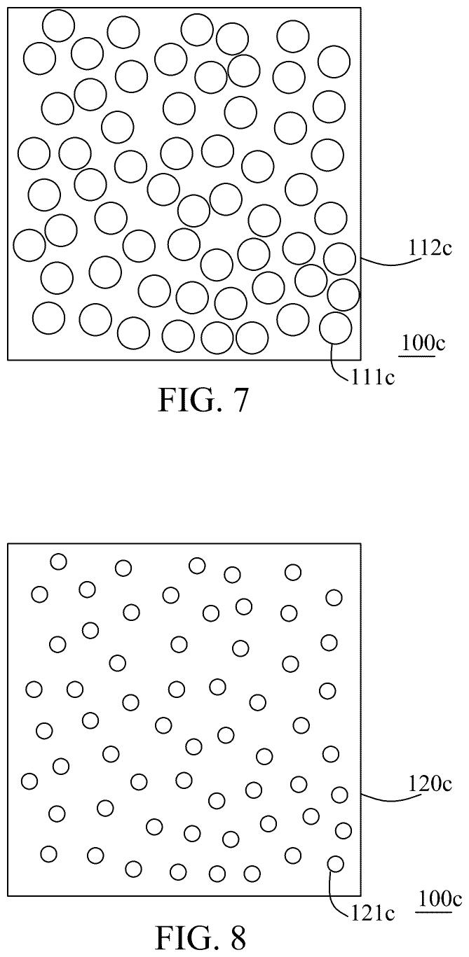

Refer to FIGS. 7 and 8, which illustrate the random arrangement of the microstructures 111c and the apertures 121c. In this embodiment, the microstructures 111c and the apertures 121c are randomly distributed on the main body 112c or the opaque layer 120c, and do not have to strictly follow a specific arrangement pattern. It is worth noting that even if the microstructures 111c and the apertures 121c are randomly arranged, there is still a corresponding positional relationship between the microstructures 111c and the apertures 121c, which is related to the manufacturing method of the optical film 100c, and this feature will be described later.

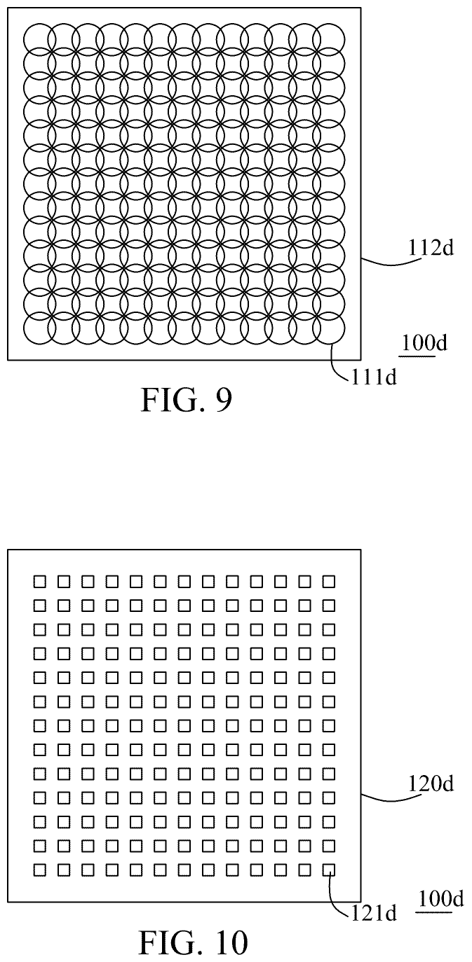

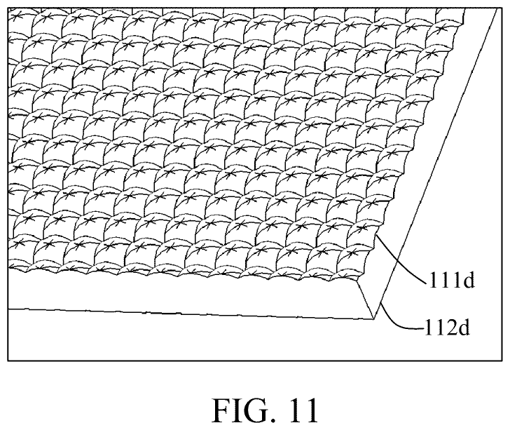

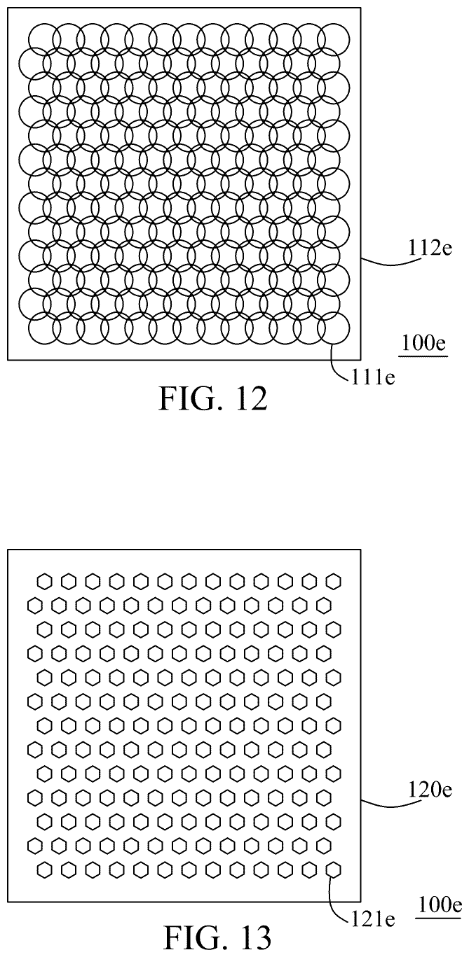

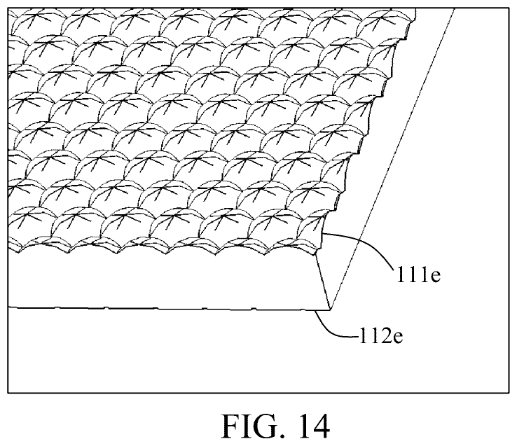

In addition, the microstructures 111 do not have to be completely independent of each other. In some embodiments, the microstructures 111 can also intersect with each other. Refer to FIGS. 9, 10, 11, 12, 13, and 14, FIGS. 9 to 11 illustrate the array and intersecting arrangement of the microstructures 111d, and FIGS. 12 to 14 illustrate the honeycomb arrangement and intersecting arrangement of the microstructures 111e. FIG. 11 is a three-dimensional image of the array and intersecting arrangement of the microstructures 111d, and FIG. 14 is a three-dimensional image of the honeycomb arrangement and intersecting arrangement of the microstructures 111e. In this embodiment, each microstructure 111d, 111e overlaps with the adjacent microstructures 111d, 111e to form an intersecting arrangement. And the apertures 121d, 121e of the opaque layer 120d, 120e still correspond to the microstructures 111d, 111e.

It is worth noting that in the embodiments of FIGS. 9 to 14, the equivalent diameter A of the microstructures 111 refers to the diameter of the microstructures 111d and 111e, specifically, it is the polygon formed by the intersection points of the microstructures 111d or 111e, and its diagonal length is the equivalent diameter A of the microstructures 111. And the apertures 121d, 121e are formed by the microstructures 111d or 111e, so the apertures 121d, 121e may form a polygon shape, the diagonal length of these polygons is the equivalent diameter d of the apertures 121d, 121e. The following will explain the manufacturing method of the optical film 100.

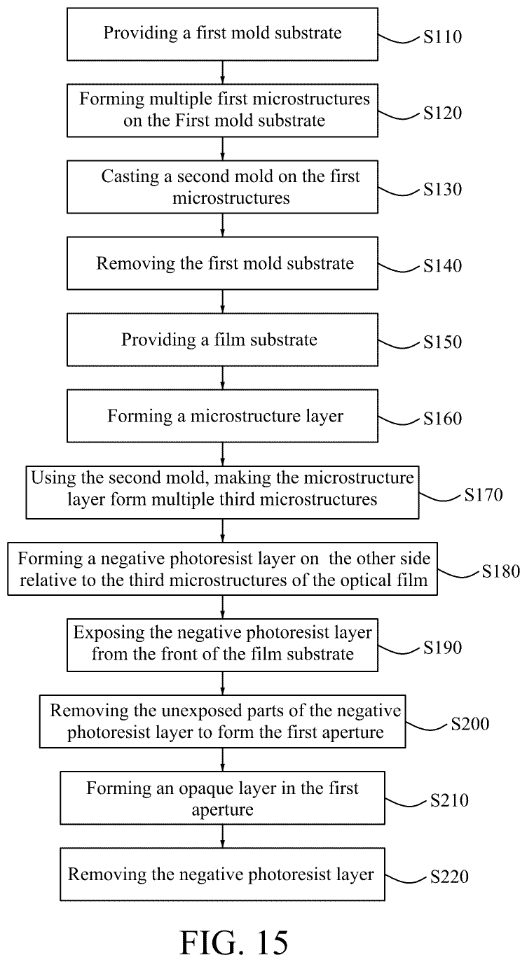

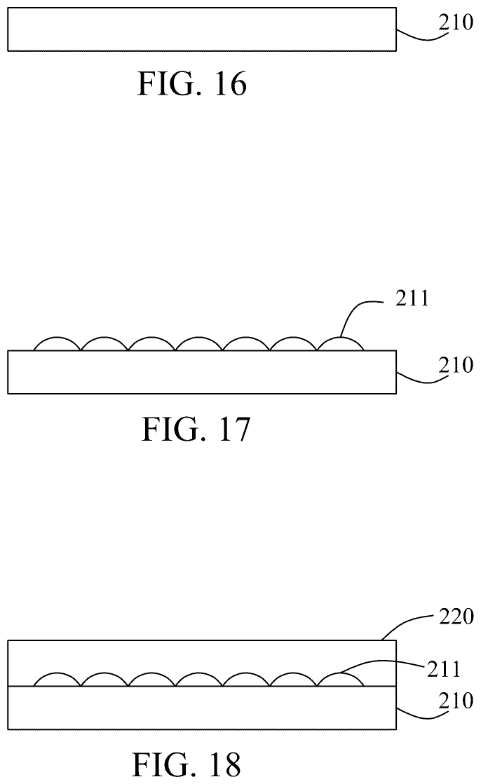

Refer to FIGS. 15 and 16 to 28, which illustrate the manufacturing method of the optical film 100 of this patent. First, step S110 is performed (as shown in FIG. 16), providing a first mold substrate 210. Then, step S120 is performed (as shown in FIG. 17), forming multiple first microstructures 211 on the first mold substrate 210, for example, using lithography or diamond knife engraving technology to form the first microstructures 211.

In this embodiment, lithography is used in step S120 to form the first microstructures 211. Specifically, a photosensitive material is coated on the first mold substrate 210. These photosensitive materials are materials that can react to light (usually ultraviolet light), and their chemical structure will change due to the irradiation of light. Then, exposure is performed using a mask, and the pattern on the mask can be projected onto the photosensitive material through light. Then, a developer liquid is used to wash and remove the exposed photosensitive material, and the corresponding first microstructure 211 pattern can be obtained. Finally, an etching process is performed, which can be dry etching or wet etching, using an etchant to etch away the parts not protected by the photosensitive material, leaving the desired first microstructures 211.

After the production of the first microstructures 211 is completed, step S130 is then performed (as shown in FIG. 18), casting a second mold 220 on the first microstructures 211. The second mold 220 includes multiple second microstructures 221, which correspond to the first microstructures 211. Further, in step S130, the second mold 220 is formed by electroforming. Specifically, an electrolyte containing metal ions is prepared first, and the metal ions are selected according to the material requirements of the second mold 220. Then, the first mold substrate 210 with the first microstructures 211 is placed in the electrolyte, and it is connected to the negative electrode of the direct current power supply, serving as the cathode of the electroforming. At the same time, another piece of the same metal or insoluble metal plate (such as platinum) is connected to the positive electrode of the direct current power supply, serving as the anode of the electroforming. Subsequently, when electricity is conducted, the metal ions will move from the electrolyte to the surface of the first mold substrate 210 (cathode), and undergo chemical reduction there, forming stable metal atoms and adhering to the surface of the first mold substrate 210. Since the surface of the first mold substrate 210 has the first microstructures 211, the metal atoms will adhere according to the shape of these first microstructures 211, forming second microstructures 221 of the same shape. When these metal atoms reach a certain thickness, the second mold 220 and the corresponding second microstructure 211 surface are formed.

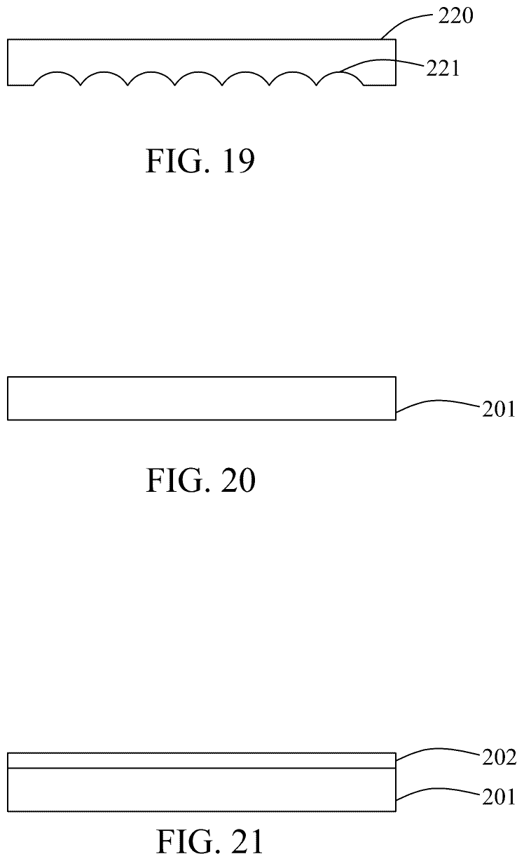

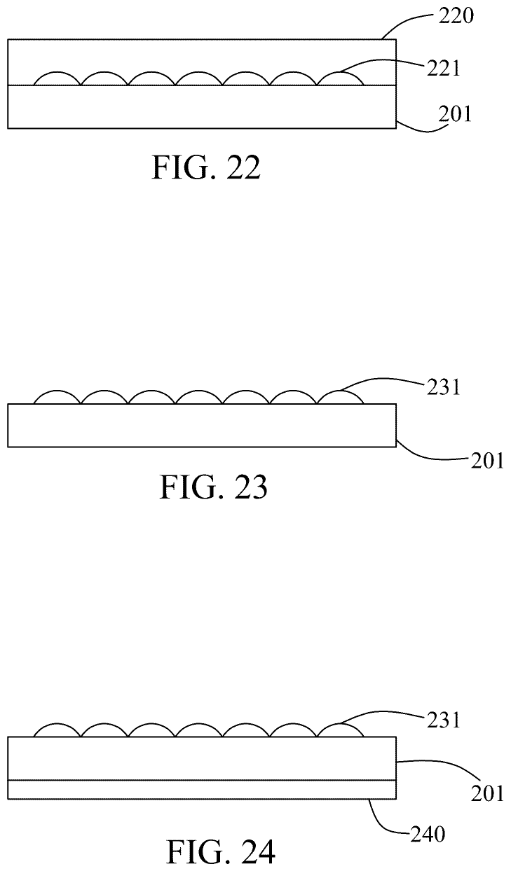

After the second mold 220 is formed, step S140 is performed (as shown in FIG. 19), removing the first mold substrate 210, leaving the second mold 220 and the second microstructures 221. Then, step S150 is performed (as shown in FIG. 20), providing a film substrate 201, the film substrate 201 is, for example, a transparent material such as polycarbonate (PC), polymethyl methacrylate (PMMA), polyethylene terephthalate (PET), or glass. Then, step S160 is performed (as shown in FIG. 21), forming a microstructure layer 202 on the film substrate 201. Then, step S170 is performed (as shown in FIG. 22), using the second mold 220, the second microstructures 221 are transferred to the microstructure layer 202, making the microstructure layer 202 form multiple third microstructures 231. Remove the second mold 220, and you will get a film substrate 201 with third microstructures 231 (as shown in FIG. 23).

In one embodiment, steps S150 and S170 are performed by hot stamping to form the optical film 230. First, a plastic sheet or film (that is, the microstructure layer 202) is placed on the film substrate 201. Then, the plastic sheet or film is heated above the melting point. Then, when the plastic or film is softened, the second mold 220 is pressed into the plastic sheet or film, transferring the shape of the second microstructures 221 to the plastic sheet or film. After cooling the plastic sheet or film and removing the second mold 220, a film substrate 201 with third microstructures 231 can be obtained.

In another embodiment, steps S150 and S170 are performed by UV imprinting to form the third microstructures 231. First, a UV-curable resin is coated on (that is, the microstructure layer 202), and then the second mold 220 is made to contact the UV-curable resin, and a suitable pressure is applied to make the UV-curable resin and the second microstructures 221 fully adhere. Then, UV light is used to irradiate the UV-curable resin, causing the UV-curable resin to harden, and the third microstructures 231 corresponding to the second microstructures 221 can be formed. After removing the second mold 220, a film substrate 201 with third microstructures 231 can be obtained.

After obtaining a film substrate 201 with third microstructures 231, step S180 is performed (as shown in FIG. 24), forming a negative photoresist layer 240 on the optical film 230, the negative photoresist layer 240 is set on the other side relative to the third microstructures 231. The negative photoresist layer 240 is made of photosensitive material, which will undergo a chemical structure change after being exposed to light.

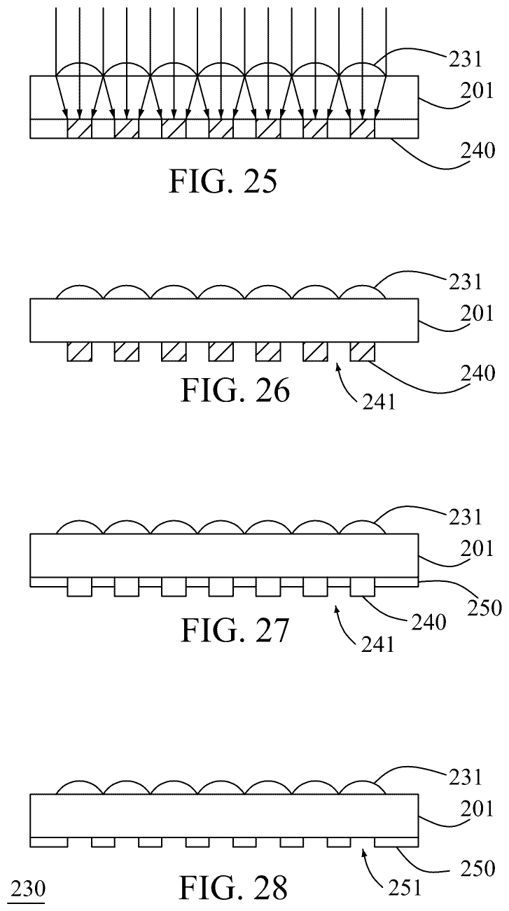

Then, step S190 is performed (as shown in FIG. 25), exposing the negative photoresist layer 240 from the front of the film substrate 201, that is, the side with the third microstructures 231. At this time, the third microstructures 231 can produce the effect of a miniature lens, because its arcuate surface can focus the exposed light at a specific position, allowing the exposed light to be guided to a specific position on the negative photoresist layer 240.

After exposure, step S200 is performed (as shown in FIG. 26), removing the unexposed parts of the negative photoresist layer 240. Specifically, the part of the negative photoresist layer 240 that is exposed to light will undergo a chemical change and harden, and a developer can be used to remove the unexposed part, thereby forming the first aperture 241 on the negative photoresist layer 240. In steps S180 to S200, self-alignment technology is used, using the third microstructures 231 and optical characteristics to form the first aperture 241 on the negative photoresist layer 240, so the first aperture 241 and the third microstructures 231 will have a corresponding position.

After forming the first aperture 241, step S210 is performed (as shown in FIG. 27), forming an opaque layer 250 in the first aperture 241. Then, step S220 is performed (as shown in FIG. 28), removing the negative photoresist layer 240, thereby obtaining an opaque layer 250 with multiple second apertures 251, these second apertures 251 correspond to the apertures 121 in FIG. 1. This completes the manufacturing of the optical film 230 (100) of this patent, and the simulation and experimental results of the optical film 100 will be explained next.

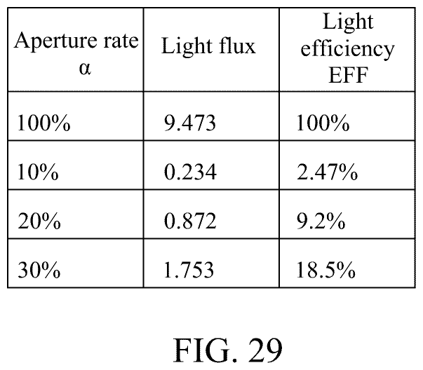

Please refer to FIG. 29, which shows the optical simulation result table. In this simulation, the parameters used include the aperture rate a and the light efficiency EFF. The aperture rate describes the ratio of the aperture area to the total area of the optical film 100, while the light efficiency describes the percentage of the remaining light flux after the light passes through the optical film 100. In addition, the optical film 100 used in the simulation is an array of microstructures 111, each with a length and width of 5 mm and a thickness of 0.1 mm. The optical film 100 with aperture rates a of 100%, 10%, 20%, and 30% were used for multiple simulations. The light source is a 5050 LED package.

In FIG. 29, the optical film 100 was not used, that is, the aperture rate a is 100%. In this case, the light flux is 9.473 units, and the light efficiency is 100%, because there is no material blocking the passage of light. When the optical film 100 with an aperture rate a of 10% is used, the light flux decreases to 0.234 units, and the corresponding light efficiency EFF is 2.47%. When the optical film 100 with an aperture rate a of 20% is used, the light flux increases to 0.872 units, and the corresponding light efficiency EFF is 9.2%. When the optical film 100 with an aperture rate a of 30% is used, the light flux further increases to 1.753 units, and the corresponding light efficiency EFF is 18.5%.

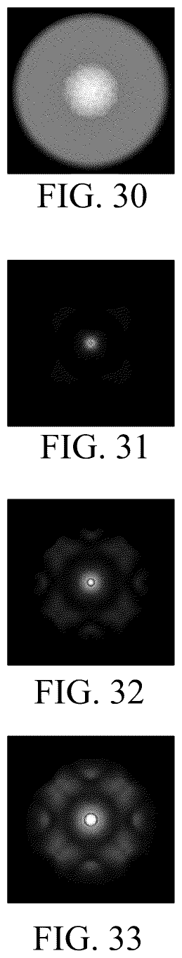

Next, please refer to FIGS. 30 to 33, which are light distribution simulation diagrams. In FIG. 30, the optical film 100 was not used (corresponding to the aperture rate a of 100% in FIG. 29), and the light emitted by the light source is completely divergent. In FIG. 31, an optical film 100 with an aperture rate of 10% was used (corresponding to the aperture rate a of 10% in FIG. 29), and it can be observed that the light is significantly concentrated in the center, and the brightness is relatively reduced. In FIG. 32, an optical film 100 with an aperture rate of 20% is used (corresponding to the aperture rate a of 20% in FIG. 29), and the light is still concentrated in the center, and compared to FIG. 31, the brightness and area have slightly increased. In FIG. 33, an optical film 100 with an aperture rate of 30% is used (corresponding to the aperture rate a of 30% in FIG. 29), the situation of light concentrated in the center is maintained, the brightness and area are higher than in FIG. 32, and some brightness can also be observed around the edges. From the simulation results, it can be seen that the optical film 100 has the ability to control the light. When the light passes through the microstructures 111 of the film, its propagation path and distribution will change due to the intervention of the microstructures 111.

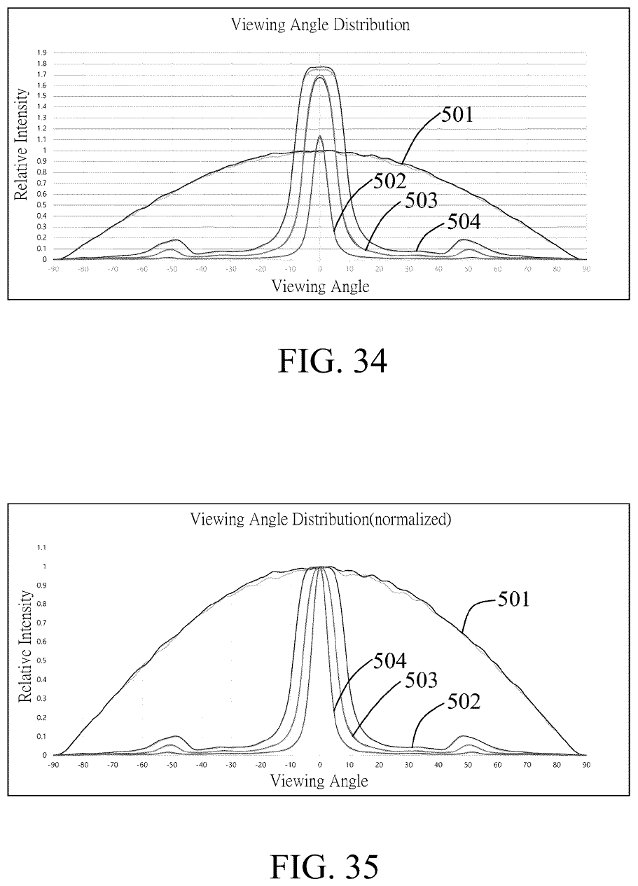

Next, please refer to FIGS. 34 and 35, which are light distribution diagrams. This light distribution diagram corresponds to FIGS. 30 to 33, and is used to show the light intensity from different viewing angles. Among them, FIG. 34 uses light intensity as the unit of the vertical axis, and FIG. 35 uses relative light intensity as the vertical axis. Also, curve 501 corresponds to FIG. 30; curve 502 corresponds to FIG. 31; curve 503 corresponds to FIG. 32; curve 504 corresponds to FIG. 33. In this figure, 0 degrees is equivalent to viewing perpendicular to the optical film 100, and ±90 degrees is equivalent to viewing parallel to the optical film 100.

From FIGS. 34 and 35, it can be seen that because the optical film 100 was not used, the curve 501 is quite smooth, the light intensity is the greatest at 0 degrees, and the light intensity gradually decreases as it approaches ±90 degrees, in other words, light can be seen from the majority of angles. However, curves 502 to 504 have the greatest light intensity within a range of ±10 degrees, and the light intensity drops significantly outside the ±10 degree range. This means that after using the optical film 100, good light intensity can be obtained within a range of ±10 degrees, which also means that it can be viewed within a range of ±10 degrees. It is worth noting that at the position of ±50 degrees, curves 503 and 504 have a protruding phenomenon. This means that when the aperture rate is larger, there will be a light leakage phenomenon at this position.

Please refer to FIGS. 36 to 39, which are light distribution simulation diagrams of another embodiment. In this embodiment, the optical film 100 used in the simulation is an array of microstructures 111, each with a length and width of 5 mm and a thickness of 0.1 mm, and the light source is a 5050 LED or backlight module package, this backlight module includes commonly used components of the backlight module such as a diffuser plate (Diffuser Plate) and a brightness enhancement film (Brightness Enhancement Film or Dual Brightness Enhancement Film).

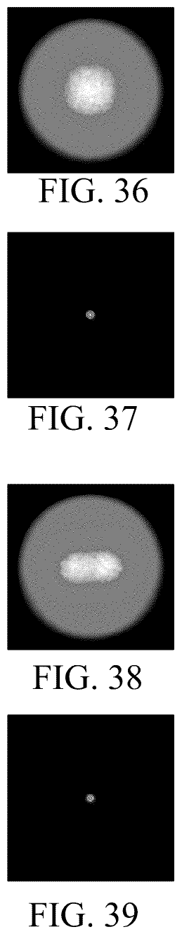

In FIG. 36, an LED is used as the light source, the optical film 100 is not used, and the light emitted by the light source is completely divergent. In FIG. 37, an optical film 100 with an aperture rate of 10% was used, and it can be observed that the light is significantly concentrated in the center.

In FIG. 38, a display module is used as the light source, the optical film 100 is not used, the light emitted by the light source is completely divergent, and is affected by the diffuser plate or enhancement film, the light intensity is stronger in the vertical direction. In FIG. 39, an optical film 100 with an aperture rate of 10% was used on the display module, and it can be observed that the light is significantly concentrated in the center, which is quite similar to the simulation result in FIG. 37.

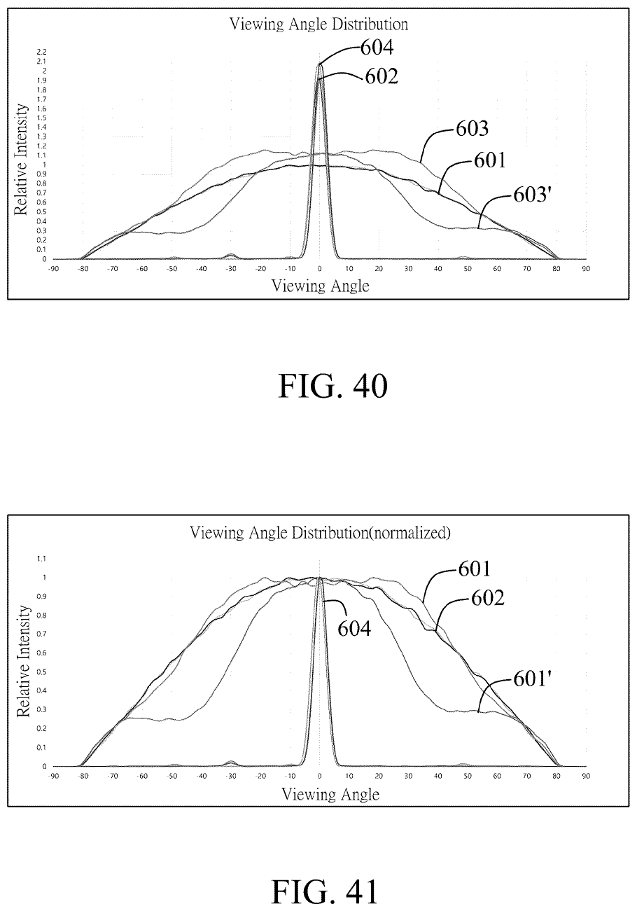

Refer to FIGS. 40 and 41, which illustrate the light distribution graph. As can be seen, curve 601 corresponds to FIG. 36; curve 602 corresponds to FIG. 37; curves 603 and 603′ correspond to FIG. 38, where curve 603 represents the light intensity in the horizontal direction, and curve 603′ represents the light intensity in the vertical direction; curve 604 corresponds to FIG. 39. From FIGS. 40 and 41, it can be seen that for curves 601, 603, and 603′, i.e., when the optical film 100 is not used, the curves are quite smooth, with the light intensity being the greatest at 0 degrees and gradually decreasing as it approaches ±90 degrees. In other words, light can be seen from the majority of angles. Curves 602 and 604, however, have the greatest light intensity within a range of ±10 degrees, and the light intensity drops significantly outside the ±10 degree range.

Combining the simulation results from FIGS. 30 to 35 and FIGS. 36 to 41, it can be seen that after using the optical film 100 of this patent, light can be effectively concentrated within a range of ±10 degrees, achieving a degree of privacy protection. Moreover, whether using a simple LED or a display module (including a diffuser plate and enhancement film) as the light source, the optical film 100 of this patent can produce considerable results after refraction. Next, the application of the optical film 100 of this patent as a component in optical devices will be explained.

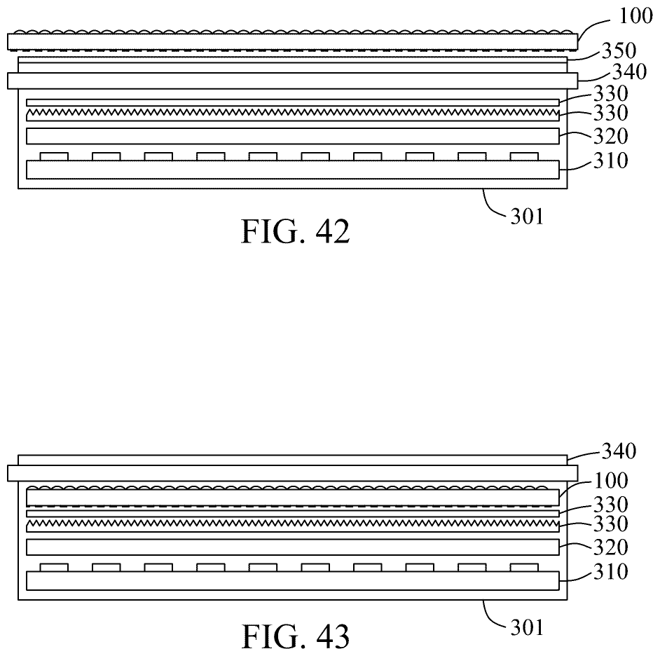

Refer to FIG. 42, which illustrates the first embodiment of the application. In the embodiment of FIG. 42, the optical film 100 is directly covered on the display module 301, using an optically transparent adhesive 350 (OCA) for fixation. Therefore, the optical film 100 will be set above the light source 310, diffuser plate 320, optical component 330, and liquid crystal panel 340. Specifically, in the embodiment of FIG. 42, the optical film 100 is affixed to a display screen's display module, achieving a privacy effect.

Refer to FIG. 43, which illustrates the second embodiment of the application. In the embodiment of FIG. 43, the optical film 100 is integrated into the display module 301. The optical film 100 will be set between the optical component 330 and the liquid crystal panel 340.

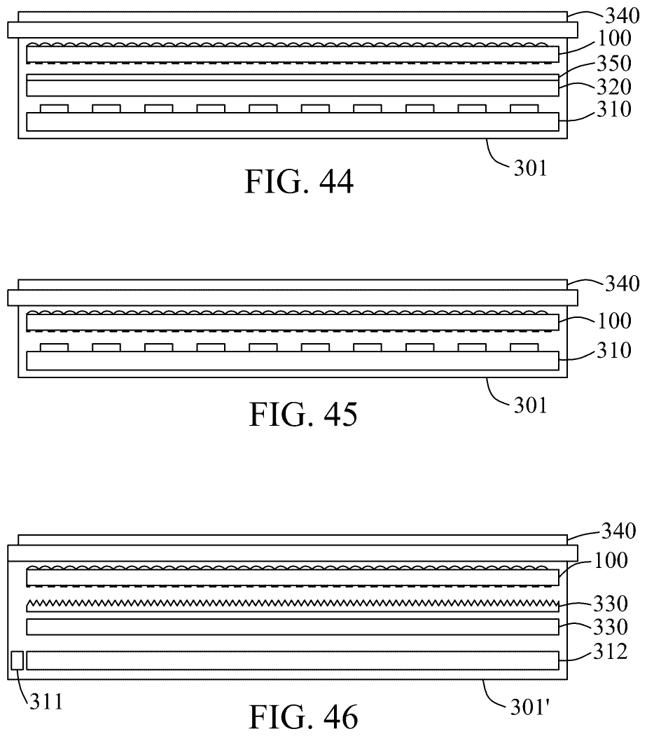

Refer to FIG. 44, which illustrates the third embodiment of the application. In the embodiment of FIG. 44, the optical film 100 replaces the original optical component 330 in the display module 301. Therefore, the optical film 100 will be set on the diffuser plate 320. In one embodiment, an optically transparent adhesive 350 (OCA) can be used to adhere to the diffuser plate 320. In other words, the diffuser plate 320 is adhered to the underside of the optical film 100 via the optically transparent adhesive 350.

Refer to FIG. 45, which illustrates the fourth embodiment of the application. In the embodiment of FIG. 45, the display module 301 is set with the optical film 100 alone. This can further reduce the thickness of the display module 301.

Refer to FIG. 46, which illustrates the fifth embodiment of the application. In the embodiment of FIG. 46, the optical film 100 is integrated into another type of display module 301′. The optical film 100 will be set between the optical component 330 and the liquid crystal panel 340. Below the optical component 330 is a light guide plate 312 (Light Guide Plate), and a light-emitting component 311 is set on the side of the light guide plate 312.

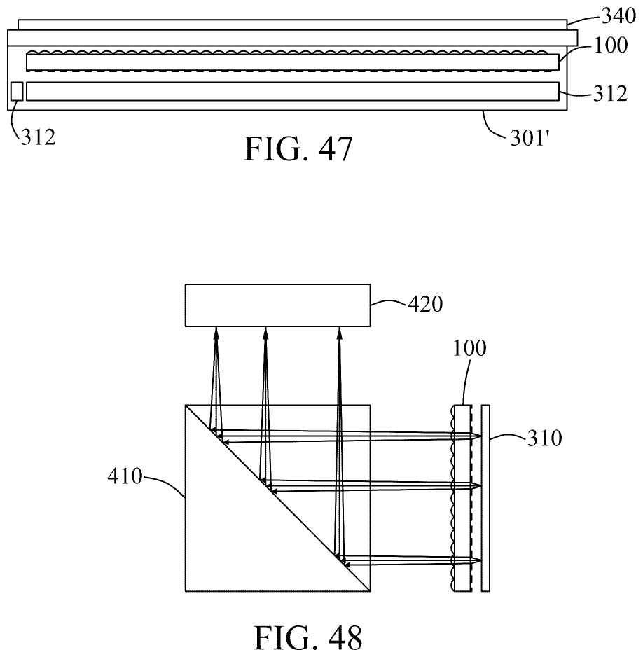

Refer to FIG. 47, which illustrates the sixth embodiment of the application. In the embodiment of FIG. 47, the display module 301′ is set with the optical film 100 alone. This can further reduce the thickness of the display module 301′.

FIGS. 42 to 46 use different ways to integrate the optical film 100 into the display module 301, utilizing the characteristics of the optical film 100, and effectively controlling the propagation of light, achieving a privacy effect.

Refer to FIG. 48, which illustrates the seventh embodiment of the application. In the embodiment of FIG. 48, it is integrated with a polarizing beam splitter 410 (Polarizing Beam Splitter, PBS). The light emitted by the light source 310 will form collimated light after passing through the optical film 100. This collimated light is further reflected by the polarizing beam splitter to the spatial light modulator 420, which is, for example, a Liquid Crystal on Silicon (LCOS) component.

Due to the optical film 100 of this patent providing collimated light, which has better uniformity and transmission efficiency, it can be used in conjunction with a polarizing beam splitter and LCOS components in projectors, head-mounted devices, virtual reality devices, etc., providing better resolution and image quality. Moreover, the optical film 100 of this patent can replace various films or lenses and other optical components in projectors, head-mounted devices, and virtual reality devices, further reducing the thickness and manufacturing cost of the device.

In summary, the optical film 100 of this patent, utilizing the relationship between the microstructures 111 and the apertures 121 of the opaque layer 120, can effectively produce collimated light. It can be extremely useful in many applications. For example, it can be used as a privacy film, providing privacy protection. This film allows viewing of the display from specific angles, and content cannot be seen from other angles, making it applicable for devices used in public places, such as ATMs or personal computers.

The optical film 100 can also be used in head-mounted devices, such as virtual reality (VR) headsets. Collimated light has a more effective light transmission efficiency, reducing light scattering and reflection, therefore the optical film can help improve display quality, providing clearer, more vivid images, better contrast, and more vibrant colors. The optical film 100 can also replace some of the lenses or films and other optical components in the display module, further reducing the thickness and manufacturing cost of the display module.

The above embodiments are just for the sake of explanation and are examples. Although modifications can be made by those skilled in the technical field to which this patent belongs, they will not depart from the scope of protection desired in the claims.

I claim:

1. An optical film, configured for use as a component of an optical device that includes a light source, the optical film comprising:
a main body;
multiple microstructures, positioned on one side of the main body, the microstructures being protruding arcuate structures; and
an opaque layer, affixed to the main body, and set opposite the microstructures on the other side of the main body, the opaque layer having multiple apertures;
wherein the center point of the apertures overlaps with the center point of the microstructures on a projection plane;
wherein the equivalent diameter of the apertures divided by the equivalent diameter of the microstructures is less than or equal to 0.3, the equivalent diameter of the microstructures divided by the thickness of the main body is less than or equal to 1.3, and greater than or equal to 0.7;
wherein the opaque layer is oriented towards the light source.

2. The optical film as claimed in claim 1, wherein the microstructures and apertures are uniformly arranged on the main body.

3. The optical film as claimed in claim 1, wherein the microstructures and apertures are arranged in an array pattern.

4. The optical film as claimed in claim 1, wherein the microstructures and apertures are arranged in a honeycomb pattern.

5. The optical film as claimed in claim 1, wherein the microstructures and apertures are randomly arranged on the main body.

6. The optical film as claimed in claim 1, wherein the microstructures intersect with each other on the main body.

7. The optical film as claimed in claim 1, wherein the opaque layer is composed of light-absorbing material.

8. The optical film as claimed in claim 1, wherein the main body is made of polycarbonate (PC), polymethyl methacrylate (PMMA), polyethylene terephthalate (PET), or glass, and the opaque layer is made of nickel, silver, gold, aluminum, titanium dioxide, or silicon dioxide.

9. The optical film as claimed in claim 1, wherein the opaque layer is a reflective material.

10. A display module, comprising:
at least one optical film comprising:
a main body;
multiple microstructures, positioned on one side of the main body, the microstructures being protruding arcuate structures; and
an opaque layer, affixed to the main body, and set opposite the microstructures on the other side of the main body, the opaque layer having multiple apertures;
wherein the center point of the apertures overlaps with the center point of the microstructures on a projection plane;
wherein the equivalent diameter of the apertures divided by the equivalent diameter of the microstructures is less than or equal to 0.3, the equivalent diameter of the microstructures divided by the thickness of the main body is less than or equal to 1.3, and greater than or equal to 0.7;
wherein the opaque layer is oriented towards the light source; and
multiple light sources, placed below the optical film;
wherein the optical film is oriented with the side having the opaque layer facing the light sources.

11. The display module as claimed in claim 10, further includes at least one diffusion layer, positioned between the optical film and the light sources.

12. The display module as claimed in claim 11, wherein the diffusion layer is affixed to the underside of the optical film.

13. The display module as claimed in claim 10, further includes a liquid crystal panel, positioned above the optical film.

14. The display module as claimed in claim 10, further includes a polarizing beam splitter and a spatial light modulator, with the polarizing beam splitter placed above the optical film. The light emitted by the light sources is reflected by the polarizing beam splitter to the spatial light modulator.

15. A display screen, comprising:
a display module; and
at least one optical film comprising:
a main body;
multiple microstructures, positioned on one side of the main body, the microstructures being protruding arcuate structures; and
an opaque layer, affixed to the main body, and set opposite the microstructures on the other side of the main body, the opaque layer having multiple apertures;
wherein the center point of the apertures overlaps with the center point of the microstructures on a projection plane;
wherein the equivalent diameter of the apertures divided by the equivalent diameter of the microstructures is less than or equal to 0.3, the equivalent diameter of the microstructures divided by the thickness of the main body is less than or equal to 1.3, and greater than or equal to 0.7;
wherein the opaque layer is oriented towards the light source;
wherein the optical film is affixed to the display module, with the optical film oriented such that the side with the opaque layer faces the display module.
